(19) United States
(12) Patent Application Publication
(10) Pub. No.: US 2007/0294237 A1
(43) Pub. Date: Dec. 20, 2007

(54) Enterprise-Wide Configuration Management Database Searches

(76) Inventors: Mariam John, Austin, TX (US); Nader W. Moussa, Cary, NC (US); Sushma Bharat Patel, Austin, TX (US); Gregory Studer, Macungie, PA (US); Jacob Edward Yackenovich, Morrisville, NC (US)

Correspondence Address: IBM CORP (YA);C/O YEE & ASSOCIATES PC, P.O. BOX 802333, DALLAS, TX, 75380, US

(21) Appl. No.: 11/423,734

(22) Filed: Jun. 13, 2006

(51) Int. Cl. G06F 17/30

(52) U.S. Cl. 707/4

(57) ABSTRACT

A computer implemented method, data processing system, and computer program product for enabling enterprise-wide queries by linking configuration management databases (CMDBs) together. A query and unique query key to access data stored in a CMDB is received. The query is processed against data internal to the CMDB. If the information is found from the query of the CMDB, the query results are sent to the requesting user. If the query does not produce any information from the CMDB, one or more infrastructure discovery tools registered with the CMDB are used to discover one or more compatible CMDBs in the enterprise. A communications link is established between the infrastructure discovery tools registered with the CMDB and the infrastructure discovery tools registered with the one or more compatible CMDBs. The query and the unique query key are then passed to the one or more compatible CMDBs via the communications link.

### BACKGROUND OF THE INVENTION

1. Field of the Invention

The present invention relates generally to accessing information in a configuration management environment, and more particularly to enabling enterprise-wide queries by linking configuration management databases together.

2. Description of the Related Art

Configuration management is the detailed recording and updating of information regarding an organization's information technology services, such as computer systems and networks, including all hardware and software components. This configuration management information is stored in a configuration management database (CMDB), which retains internally a representation of other software and hardware systems, among other data. Configuration Management Databases (CMDBs) have been proposed as part of the Information Technology Infrastructure Library (ITIL) guidelines for managing a network setup, and have been implemented in many areas. ITIL is a set of best practices standards for information technology (IT) service management.

With configuration management, IT components may be tracked and controlled. For example, if a user wants to upgrade a hardware component in the enterprise, the user may, via a configuration management application, submit a query to the CMDB and receive results identifying the components already installed in the system. From this detailed view provided to the user in the CMDB, the user may make an informed decision about the hardware upgrade needed for the system and the effects the change will have on other components and systems in the enterprise.

Although configuration information may be obtained from querying a CMDB, existing methods of accessing information from an enterprise's configuration management systems suffer from some drawbacks. For example, as each individual CMDB in an enterprise stores information about the current configuration of a piece of enterprise infrastructure, these databases contain valuable information. However, an individual CMDB can only retain information regarding a limited portion of the infrastructure. If a user queries a particular CMDB, results obtained from that CMDB will only reveal as much information as that CMDB contains. Thus, the information is limited to the particular CMDB queried. If the user needs more configuration information from other areas of the infrastructure, the user must query the other CMDBs individually to access the information in those databases.

### SUMMARY OF THE INVENTION

Embodiments of the present invention provide a computer implemented method, data processing system, and computer program product for enabling enterprise-wide queries by linking configuration management databases together. A query and unique query key to access data stored in a configuration management database is received at the configuration management database. The query is processed against data internal to the configuration management database. If the information is found from the query of the configuration management database, the query results are sent to the requesting user. If the query does not produce any information from the configuration management database, one or more infrastructure discovery tools registered with the configuration management database are used to discover one or more compatible configuration management databases in the enterprise. If one or more compatible configuration management databases are found to exist in the enterprise, a communications link is established between the infrastructure discovery tools registered with the configuration management database and the infrastructure discovery tools registered with the one or more compatible configuration management databases discovered. The query and the unique query key are then passed to the one or more compatible configuration management databases via the communications link.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which aspects of the present invention may be implemented;

FIG. 2 is a block diagram of a data processing system in which aspects of the present invention may be implemented;

FIG. 3 is a block diagram illustrating components used to enable enterprise-wide queries using linked configuration management databases in accordance with an illustrative embodiment of the present invention; and

FIG. 4 is a flowchart of a process for using linked configuration management databases to obtain access to more information than is contained in a single configuration management database in accordance with an illustrative embodiment of the present invention.

### DETAILED DESCRIPTION OF THE PREFERRED EMBODIMENT

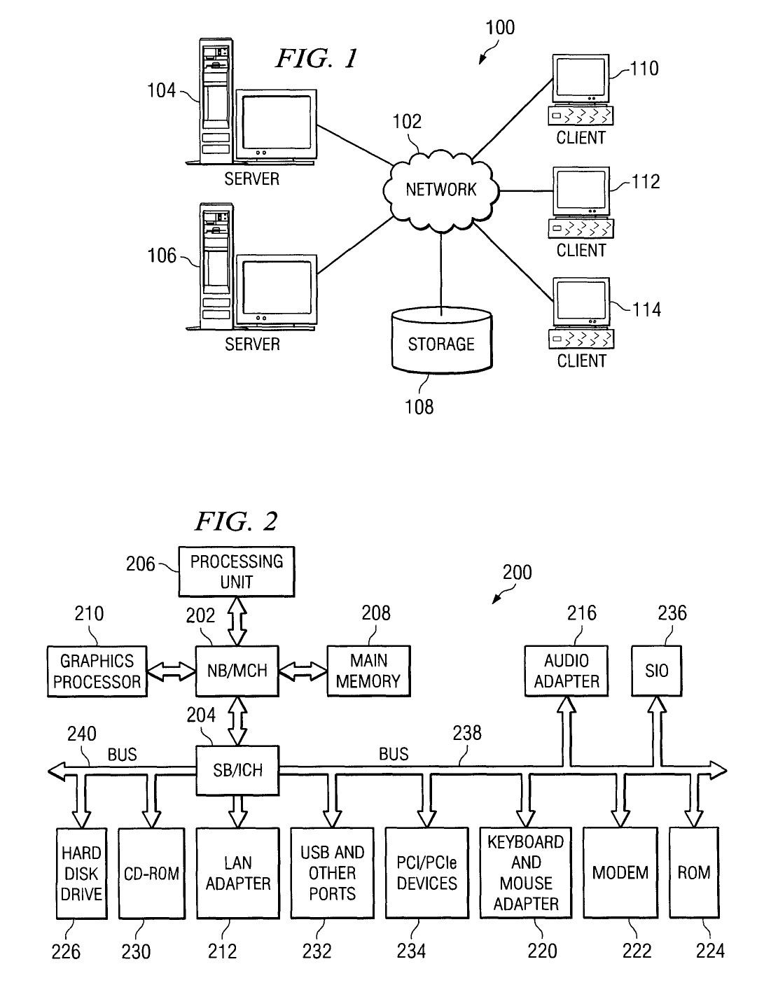

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communications unit may include one or more devices used to transmit and receive data, such as modem 222 or LAN adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Aspects of the present invention provide a computer implemented method, data processing system, and computer program product for allowing access to information stored in a plurality of configuration management databases (CMDBs) within an enterprise. With the mechanism of the present invention, users may perform enterprise-wide CMDB queries by linking or connecting CMDBs in the enterprise together. CMDBs may be linked together by using infrastructure discovery tools and registering these discovery tools on each CMDB. An infrastructure discovery tool is an application designed to discover and identify instances of CMDBs based on credentials and network address ranges. An advantage of linking CMDBs is that it becomes possible to access more information than is contained within a single CMDB. In addition, by allowing users to easily perform an enterprise-wide query of CMDBs, configuration data may subsequently be distributed in smaller data stores.

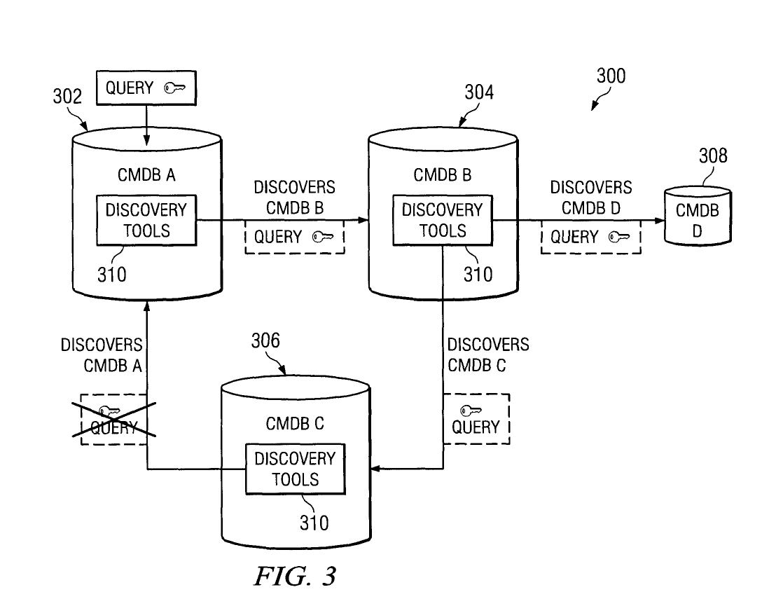

FIG. 3 is a block diagram illustrating a data processing system comprising components used to enable enterprise-wide queries through linked configuration management databases in accordance with an illustrative embodiment of the present invention. In this illustrative example, data processing system 300 comprises a plurality of CMDBs (CMDB A 302, CMDB B 304, CMDB C 306, and CMDB D 308). Each CMDB internally stores a representation of other software and hardware systems for the enterprise, among other information. This information may be pulled or pushed into the database from outside sources, such as a configuration management application. One or more infrastructure discovery tools 310 are registered with the CMDBs.

An outside source, such as a configuration management application, accesses a particular set of infrastructure information by sending a query to a CMDB, such as CMDB A 302. When a query is issued to a CMDB, the query is assigned a unique query key value. The unique query key value is unique to the particular query in that it is guaranteed that no other subsequent query will be assigned the same key value for many times the length of time a query takes to complete. The unique query key value may be assigned to the query via the configuration management application when the query is issued. In an alternative embodiment, the CMDB may assign a unique query key value to the query. For example, upon receiving a query, the CMDB may assign a unique query key value to the query if the CMDB determines that the query does not already contain a unique query key value (i.e., new query). On the other hand, if the CMDB determines that the query already contains a unique query key value, the CMDB does not assign a key value to the query.

When the query is received, CMDB A 302 searches its internal data to gather results for the query. If information is found from the search, CMDB A 302 sends the results of the query to the requesting user. If CMDB A 302 does not have the information to satisfy the query, the query is then passed through the infrastructure discovery tool to other CMDBs in the enterprise. Subsequent queries would continue the same path as described, since the originating application performing the query to CMDB A 302 is not aware of additional CMDBs in the enterprise.

To pass the query, CMDB A 302 establishes a communications link with infrastructure discovery tools 310 previously registered with CMDB A 302. The communications link may be, for example, a standard Java™ API communication from one Java™ application to another. The communications link may be established between CMDB A 302 and discovery tools 310 if detailed enough information has been provided to CMDB A 302. Examples of the detailed information include access credentials (username and password) and network address ranges in which to perform the compatible CMDB discovery. In one embodiment of the present invention, infrastructure discovery tools 310 may act as a proxy for communication between CMDBs or provide the ability to discover suitable proxies. Thus, rather than establishing direct communication among the requesting CMDB and the remote CMDBs, a CMDB may connect to the discovery tools and request information stored in the remote CMDBs, and a discovery tool agent will connect to the remote CMDBs and provide the requested information to the requesting CMDB. Using a proxy in this manner provides faster communication and a generic method of communication between different database types.

Once a communications link is established, CMDB A 302 sends a request to discovery tools 310 to search the enterprise infrastructure for compatible remote CMDBs known by CMDB A 302. Compatible CMDBs are CMDBs that use a similar database schema to store key details on metadata, resources, and relationships. Key details include identity of resource instances, the relationships between resource instances, and data model representations of supported resource metadata information. It should be noted that the discovery tools registered with each CMDB may request information about other compatible CMDBs before a query is even performed, increasing the response time from the CMDBs.

In this illustrative example, the search by discovery tools 310 results in discovering compatible remote CMDB B 304. Discovery tools 310 also identify if CMDB A 302 cannot communicate with compatible remote CMDB B 304, such as, for example, when CMDB A 302 does not have the necessary authentication credentials to access the remote CMDB or cannot penetrate a network firewall. Discovery tools 310 provide the information about the remote CMDBs and communication ability to CMDB A 302. This information may include the name and location of the remote databases, as well as the path to the databases. This information may be cached on the host CMDB server for lookup before the discovery process begins. If CMDB A 302 is able to communicate with CMDB B 304, infrastructure discovery tools 310 registered with CMDB 302 will open a communications link with infrastructure discovery tools 310 registered with remote CMDB and pass the query and query key to CMDB B 304.

Like CMDB A 302, when the query is received at remote CMDB B 304, the database first searches its own internal data to gather information pertinent to the query. Upon success of the query at CMDB B 304, CMDB 304 returns the result directly to the originating CMDB, or in this case, CMDB A 302.

Since remote CMDB B 304 is enabled with discovery tools 310, CMDB B 304 may locate other compatible remote CMDBs, such as remote CMDB C 306 and CMDB D 308, and initiate its own discovery tasks for these databases. CMDB B 304 establishes communication links to CMDB C 306 and CMDB D 308 and passes the query and unique query key to these databases. Thus, each remote CMDB enabled with discovery tools may recursively pass the query and query key along to other compatible remote CMDBs. In contrast, no discovery tools are shown to be registered with remote CMDB D 308, and the database just sends its results of the query back to the requesting database (CMDB B 304).

Each CMDB stores the unique keys of queries to which the CMDB has already provided an answer. The CMDBs store the unique query keys for a period of time many times longer than it takes for the enterprise-wide query to complete. When a CMDB receives a query having a key already stored at the CMDB, the CMDB determines that it has already processed the query. The CMDB may then refuse to perform an internal data search, as well as refuse to pass the query on to other compatible CMDBs so as to prevent infinite query loops between connected CMDBs. For example, CMDB C 306 uses discovery tools 310 to locate compatible CMDB A 302. CMDB C 306 passes the query and query key to CMDB A 302. CMDB A 302 will not process the query, however, since it knows it has already processed the query based on the key passed with the query from CMDB C 306.

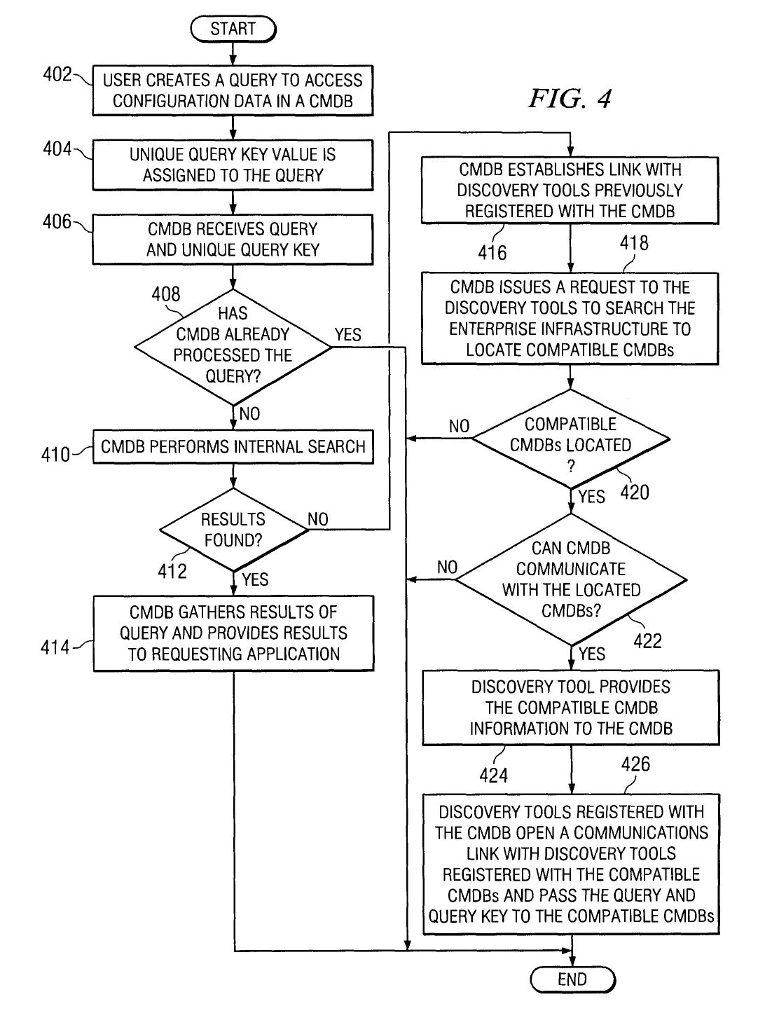

FIG. 4 is a flowchart of a process for using linked configuration management databases to obtain access to more information than is contained in a single configuration management database in accordance with an illustrative embodiment of the present invention. The process depicted in FIG. 4 may be implemented in a data processing system, such as data processing system 300 in FIG. 3.

The process begins with a user creating a query to access configuration data stored in a CMDB (step 402). When the user creates a query, a unique query key value is assigned to the query (step 404). For example, if the user uses a configuration management application to access the CMDB, the unique query key value may be generated by a configuration management application when the query is created. Alternatively, the unique query key value may be generated by the CMDB when the query is received by the CMDB and the CMDB determines that the query received does not already contain a unique query key.

Upon receiving the query and the unique query key (step 406), the CMDB determines whether the CMDB has previously processed the query (step 408). This determination may be made by comparing the query key received with a list of query keys stored in the CMDB. If the query key received matches a stored value in the CMDB, the CMDB may refuse to process the query. If the query key received does not match any stored value, the CMDB performs an internal search of the data stored in the CMDB (step 410). A determination is then made as to whether the information in the query was found in the CMDB (step 412). If information was found from the search, the CMDB gathers the results of query and sends the results of the query to the requesting user (step 414), with the process terminating thereafter. If the CMDB does not have the information to satisfy the query, the CMDB establishes a link with discovery tools previously registered with the CMDB. The CMDB issues a request to the discovery tools to search the enterprise infrastructure to locate compatible CMDBs (step 418).

A determination is then made as to whether the discovery tools have located one or more compatible remote CMDBs in the enterprise (step 420). If no compatible CMDBs are discovered, the search ends, and the process terminates thereafter. If the discovery tools find compatible CMDBs, a determination is made by the discovery tools as to whether the CMDB can communicate with the discovered compatible CMDBs (step 422). If the discovery tools determine that the CMDB cannot communicate with the discovered compatible CMDBs, the search ends, and the process terminates thereafter. If the discovery tools determine that the CMDB can in fact communicate with the discovered compatible CMDBs, the discovery tools pass the information about the discovered compatible CMDBs to the CMDB (step 424). The discovery tools registered with the CMDB may then open a communications link with the discovery tools registered with the compatible CMDBs and pass the query and query key to these databases (step 426). When the query is received at these compatible CMDBs, the databases may then each perform the tasks in steps 410-426, including performing their own internal data search for the query, return the results to the requesting CMDB, and, if enabled with discovery tools, pass the query and query key to other compatible CMDBs.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and digital video disc (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for performing an enterprise-wide configuration management database query, the computer implemented method comprising:
receiving, at a configuration management database, a query and a unique query key from a user to access the configuration management database;
processing the query against data internal to the configuration management database;
responsive to a failure to obtain information from the query of the configuration management database, using one or more infrastructure discovery tools registered with the configuration management database to discover one or more compatible configuration management databases in the enterprise;
establishing a communications link between the infrastructure discovery tools registered with the configuration management database and infrastructure discovery tools registered the one or more compatible configuration management databases; and
passing the query and the unique query key to the one or more compatible configuration management databases via the communications link.

2. The computer implemented method of claim 1, further comprising:
responsive to obtaining information from the query of the configuration management database, sending results of the query to the user.

3. The computer implemented method of claim 1, wherein the processing, sending, using, establishing, and passing steps are performed by each of the one or more compatible configuration management databases upon receiving the query and the unique query key.

4. The computer implemented method of claim 1, wherein the receiving step further comprises:
determining whether the configuration management database has already processed the query by comparing the unique query key received from the user against a list of query keys stored by the configuration management database; and
terminating processing of the query received at the configuration management database in response to a determination that the configuration management database has already processed the query.

5. The computer implemented method of claim 1, wherein the unique query key is used to identify the query for a period of time longer than the time needed to complete the enterprise-wide configuration management database query to prevent concurrent queries from being assigned a same query key.

6. The computer implemented method of claim 1, wherein the unique query key is assigned to the query by a configuration management application when the query is created.

7. The computer implemented method of claim 1, the unique query key is assigned to the query by the configuration management database if the query does not already contain a unique query key.

8. The computer implemented method of claim 1, wherein the one or more infrastructure discovery tools act as a proxy for communication between the configuration management database and the one or more compatible configuration management databases.

9. The computer implemented method of claim 1, wherein the using step includes using the one or more infrastructure discovery tools to determine that the first configuration management database is able to communicate with the one or more compatible configuration management databases.

10. A data processing system for performing an enterprise-wide configuration management database query, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to receive, at a configuration management database, a query and a unique query key from a user to access the configuration management database, process the query against data internal to the configuration management database, use one or more infrastructure discovery tools registered with the configuration management database to discover one or more compatible configuration management databases in the enterprise in response to a failure to obtain information from the query of the configuration management database, establish a communications link between the infrastructure discovery tools registered with the configuration management database and infrastructure discovery tools registered the one or more compatible configuration management databases, and pass the query and the unique query key to the one or more compatible configuration management databases via the communications link.

11. The data processing system of claim 10, wherein the processing unit further executes the computer usable code to send results of the query to the user in response to obtaining information from the query of the configuration management database.

12. The data processing system of claim 10, wherein the processing, sending, using, establishing, and passing steps are performed by each of the one or more compatible configuration management databases upon receiving the query and the unique query key.

13. The data processing system of claim 10, wherein the computer usable code to receive a query further comprises computer usable code to determine whether the configuration management database has already processed the query by comparing the unique query key received from the user against a list of query keys stored by the configuration management database, and terminate processing of the query received at the configuration management database in response to a determination that the configuration management database has already processed the query.

14. A computer program product for performing an enterprise-wide configuration management database query, the computer program product comprising:
a computer usable medium having computer usable program code tangibly embodied thereon, the computer usable program code comprising:
computer usable program code for receiving, at a configuration management database, a query and a unique query key from a user to access the configuration management database;
computer usable program code for processing the query against data internal to the configuration management database;
computer usable program code for using one or more infrastructure discovery tools registered with the configuration management database to discover one or more compatible configuration management databases in the enterprise in response to a failure to obtain information from the query of the configuration management database;
computer usable program code for establishing a communications link between the infrastructure discovery tools registered with the configuration management database and infrastructure discovery tools registered the one or more compatible configuration management databases; and
computer usable program code for passing the query and the unique query key to the one or more compatible configuration management databases via the communications link.

15. The computer program product of claim 14, further comprising:
computer usable program code for sending the query result to the user in response to obtaining information from the query of the configuration management database.

16. The computer program product of claim 14, wherein the computer usable program code for processing, sending, using, establishing, and passing are performed by each of the one or more compatible configuration management databases upon receiving the query and the unique query key.

17. The computer program product of claim 14, wherein the computer usable program code for receiving further comprises:
computer usable program code for determining whether the configuration management database has already processed the query by comparing the unique query key received from the user against a list of query keys stored by the configuration management database; and
computer usable program code for terminating processing of the query received at the configuration management database in response to a determination that the configuration management database has already processed the query.

18. The computer program product of claim 14, wherein the unique query key is used to identify the query for a period of time longer than the time needed to complete the enterprise-wide configuration management database query to prevent concurrent queries from being assigned a same query key.

19. The computer program product of claim 14, wherein the unique query key is assigned to the query by a configuration management application when the query is created.

20. The computer program product of claim 14, the unique query key is assigned to the query by the configuration management database if the query does not already contain a unique query key.
